(19) United States
(12) Patent Application Publication
(10) Pub. No.: US 2022/0168909 A1
(43) Pub. Date: Jun. 2, 2022

(54) Fusing a Static Large Field of View and High Fidelity Moveable Sensors for a Robot Platform

(71) Applicant: X Development LLC, Mountain View, CA (US)

(72) Inventors: Guy Satat, Sunnyvale, CA (US); Eden Rephaeli, Oakland, CA (US)

(21) Appl. No.: 17/106,906

(22) Filed: Nov. 30, 2020

(51) Int. Cl. B25J 19/02; B25J 9/16; B25J 5/00; G06T 1/00; G06T 7/73

(52) U.S. Cl. CPC B25J 19/023; B25J 9/1697; G06T 7/73; G06T 1/0014; B25J 5/007

(57) ABSTRACT

A method includes receiving, from at least two fixed cameras in a static sensor arrangement on a mobile robotic device, one or more images representative of an environment of the mobile robotic device, wherein the at least two fixed cameras have a combined 360 degree horizontal field of view around the mobile robotic device. The method further includes determining, from the one or more images, a presence of an object in the environment of the mobile robotic device. The method additionally includes controlling a moveable sensor arrangement of the mobile robotic device to move towards the object, wherein the movable sensor arrangement comprises at least one movable camera on the mobile robotic device. The method also includes receiving, from the at least one movable camera of the moveable sensor arrangement, one or more additional images representative of the object.

### BACKGROUND

As technology advances, various types of robotic devices are being created for performing a variety of functions that may assist users. Robotic devices may be used for applications involving material handling, transportation, welding, assembly, and dispensing, among others. Over time, the manner in which these robotic systems operate is becoming more intelligent, efficient, and intuitive. As robotic systems become increasingly prevalent in numerous aspects of modern life, it is desirable for robotic systems to be efficient. Therefore, a demand for efficient robotic systems has helped open up a field of innovation in actuators, movement, sensing techniques, as well as component design and assembly.

### SUMMARY

Example embodiments involve specialized sensing systems on a robotic device. A robotic device may be equipped with a static sensor arrangement and a moveable sensor arrangement. The static sensor arrangement may combine cameras for a 360 horizontal degree field of view and may facilitate the detection of the presence of an object in the environment of the robotic device. The moveable sensor arrangement may be controlled by the robotic device to obtain one or more additional images representative of the object.

In an embodiment, the method includes receiving, from at least two fixed cameras in a static sensor arrangement on a mobile robotic device, one or more images representative of an environment of the mobile robotic device, wherein a field of view of each of the at least two fixed cameras overlaps a field of view of a different one of the at least two fixed cameras, and wherein the at least two fixed cameras have a combined 360 degree horizontal field of view around the mobile robotic device. The method further includes determining, from the one or more images, a presence of an object in the environment of the mobile robotic device. The method additionally includes controlling a moveable sensor arrangement of the mobile robotic device to move towards the object, wherein the movable sensor arrangement comprises at least one movable camera on the mobile robotic device. The method also includes receiving, from the at least one movable camera of the moveable sensor arrangement, one or more additional images representative of the object.

In another embodiment, a robotic device includes a static sensor arrangement with at least two fixed cameras, a moveable sensor arrangement with at least one camera, and a control system. The control system may be configured to receive, from at least two fixed cameras in a static sensor arrangement on a mobile robotic device, one or more images representative of an environment of the mobile robotic device, wherein a field of view of each of the at least two fixed cameras overlaps a field of view of a different one of the at least two fixed cameras, and wherein the at least two fixed cameras have a combined 360 degree horizontal field of view around the mobile robotic device. The control system may be further configured to determine, from the one or more images, a presence of an object in the environment of the mobile robotic device. The control system may additionally be configured to control a moveable sensor arrangement of the mobile robotic device to move towards the object, wherein the movable sensor arrangement comprises at least one movable camera on the mobile robotic device. The control system may also be configured to receive, from the at least one movable camera of the moveable sensor arrangement, one or more additional images representative of the object.

In a further embodiment, a non-transitory computer readable medium is provided which includes programming instructions executable by at least one processor to cause the at least one processor to perform functions. The functions include receiving, from at least two fixed cameras in a static sensor arrangement on a mobile robotic device, one or more images representative of an environment of the mobile robotic device, wherein a field of view of each of the at least two fixed cameras overlaps a field of view of a different one of the at least two fixed cameras, and wherein the at least two fixed cameras have a combined 360 degree horizontal field of view around the mobile robotic device. The functions further include determining, from the one or more images, a presence of an object in the environment of the mobile robotic device. The functions additionally include controlling a moveable sensor arrangement of the mobile robotic device to move towards the object, wherein the movable sensor arrangement comprises at least one movable camera on the mobile robotic device. The functions also include receiving, from the at least one movable camera of the moveable sensor arrangement, one or more additional images representative of the object.

In another embodiment, a system is provided that includes means for receiving, from at least two fixed cameras in a static sensor arrangement on a mobile robotic device, one or more images representative of an environment of the mobile robotic device, wherein a field of view of each of the at least two fixed cameras overlaps a field of view of a different one of the at least two fixed cameras, and wherein the at least two fixed cameras have a combined 360 degree horizontal field of view around the mobile robotic device. The system further includes means for determining, from the one or more images, a presence of an object in the environment of the mobile robotic device. The system additionally includes means for controlling a moveable sensor arrangement of the mobile robotic device to move towards the object, wherein the movable sensor arrangement comprises at least one movable camera on the mobile robotic device. The system also includes means for receiving, from the at least one movable camera of the moveable sensor arrangement, one or more additional images representative of the object.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates a configuration of a robotic system, in accordance with example embodiments.

FIG. 2 illustrates a mobile robot, in accordance with example embodiments.

FIG. 3 illustrates an exploded view of a mobile robot, in accordance with example embodiments.

FIG. 4 illustrates a robotic arm, in accordance with example embodiments.

FIG. 5 is a top-down view of a static sensor arrangement involving two cameras, in accordance with example embodiments.

FIG. 6 is a top-down view of a static sensor arrangement involving three cameras, in accordance with example embodiments.

FIG. 7 is a top-down view of another static sensor arrangement involving three cameras, in accordance with example embodiments.

FIG. 8A is a side view of a robotic device, in accordance with example embodiments.

FIG. 8B is a side view of a robotic device with a fixed perception component including stereo pairs of cameras, in accordance with example embodiments.

FIG. 9A is a top-down view of a robotic device in an environment, in accordance with example embodiments.

FIG. 9B is a top-down view of another robotic device in an environment, in accordance with example embodiments.

FIG. 10 is a block diagram of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

Robotic devices are used for a variety of applications to streamline processes, such as material handling, transportation, assembly, and manufacturing. Many of these applications often occur in a controlled and predictable environment. Robotic devices in these environments may not need to be fully aware of the surroundings and changes in the surroundings while performing tasks. In these applications, robotic devices may primarily have sensors to monitor aspects of the task being performed. For example, a robotic device may be tasked with moving an object. A robotic device in this application may primarily rely on a camera at the end of an arm of the robotic device to provide information on the object and, perhaps, an initial review of the surroundings. The camera at the end of arm of the robotic device and/or the arm may be controlled to move to observe properties of an object. Additionally, the system of the camera and arm may move in conjunction to perform tasks and to observe tasks being performed. The camera at the end of arm may provide information to the robotic device on how to move the arm and associated gripper when the gripper is being used to manipulate an object. These observations may be mainly limited to aspects of the task at hand and may not include general observations of the surroundings of the robot.

With technological advances, robotic systems are increasing in complexity for applications with less and less structured circumstances, particularly in applications with human interactions. In such situations, an environment may change continuously in many ways, making it difficult for the robot to complete a requested task. For example, the robotic device may be tasked with moving a book from a table to a person. In order to perform such a task, the robotic device may first find the person in its surroundings, then the book, and subsequently observe its surroundings for a feasible path to travel. The robotic device may use its sensors to monitor the book, pick up the book, and move the book in accordance with the determined path. However, while the robotic device is moving, a human may place a cup of water next to the moving robotic arm. Since the sensors of the robotic device are monitoring the book and the placement of the cup of water may be out of the field of view of the sensors of the robotic device, the arm of the robotic device may cause the cup to flip and the water to spill. In another example, the human may be continuously moving. Without continuously monitoring the location of the human, the robotic device may have difficulty determining the final destination of the book. Thus, it may be desirable for a robotic device to be able to monitor the environment at large, all the while be able to observe elements of the environment in detail.

Provided herein are arrangements which include fixed sensors on a mobile robotic device which provide a 360 degree horizontal field of view around the robotic device. In some examples, a robotic device may have a fixed perception component and an end of arm component, the latter of which may be moved to perform tasks, e.g. manipulating objects. Both the fixed and end of arm components may contain various sensor arrangements in order to provide the robotic device with information. For example, the fixed and end of arm components may give the robotic device information on the surroundings, which may contribute to how the robotic device manipulates objects and moves through its surroundings.

The fixed perception component may include a static sensor arrangement, which may involve at least two fixed cameras, where the cameras have a combined 360 degree horizontal field of view around the robotic device. A camera herein may refer to a device comprising an imaging sensor and an associated lens and may be able to capture information representing a certain portion of the environment, depending on the position of the robotic device and the camera itself. The field of view of a sensor or a sensor arrangement may be defined by a number indicating degrees relative to a 360 degree circle. The field of view of a sensor or sensor arrangement relates to the extent to which the surroundings of the robotic device may be seen at any provided moment. For example, a sensor may have a 180 degree horizontal field of view. Such a sensor may provide the robotic device with a view of half the surroundings that are within a vertical field of view of the sensor. In another example, a sensor arrangement with a 360 degree horizontal field of view may provide to the robotic device all aspects of its surroundings that fall within the vertical field of view of the sensor.

The static sensor arrangement may include at least two fixed cameras with overlapping fields of view, where each overlapping field of view is different in order to provide a combined 360 degrees horizontal field of view. In some examples, the robotic device may have two cameras with horizontal fields of view greater than 180 degrees. The sensors may be arranged such that they provide information on different portions of the surroundings of the robotic device, but overlap with each other on the vertical edges of the images. For instance, the cameras may be aligned with each other but focus on opposing views of the surroundings. In some such examples, the overlapping vertical edges may be used by software running on a computing device to construct a complete 360 field of view from the information captured by the two sensors.

In further examples, the robotic device may have four cameras, where each of the four cameras has a horizontal field of view greater than 90 degrees. The four cameras may be arranged to provide information around the same horizontal plane but representing different portions of the surroundings of the robotic device. The represented portions may have overlapping scenes on the vertical edges of the images. For example, the four cameras may be arranged in a square formation, where each of the four cameras points towards a corner of the square. A software program on a computing device of the robotic device may be able to use the overlapping regions to construct a complete 360 degree horizontal field of view of the surroundings. The arrangements provided above are intended as examples and are not intended to be limiting. Other arrangements may be possible. For instance, three cameras with fields of views of greater than 120 degrees each arranged to point to different corners of an equilateral triangle, five cameras with fields of view of greater than 72 degrees each arranged to point to different corners of a pentagon, and other examples are also possible.

In further examples, static sensor arrangements where cameras individually have different fields of view may also be possible. For example, the sensor arrangement may consist of one camera with a field of view greater than 180 degrees and two cameras with a field of view greater than 90 degrees. In this case, each camera may be arranged in a triangular formation where each of the three cameras point to one corner of an isosceles triangle. In this case, the camera with a field of view greater than 180 degrees may be the same distance from each of the cameras with a field of view greater than 90 degrees, such that each vertical edge of an image overlaps with the vertical edge of an image taken from another camera. Similar to above examples, a software program on a computing device may be able to use the overlapping regions to construct a complete 360 horizontal field of view of the surroundings of the static sensor arrangement. Other arrangements using cameras with different fields of views may also be possible.

In further examples, the static sensor arrangement may further utilize multiple pairs of cameras which are aligned with one another vertically, resulting in stereo pairs of cameras. The bottom portion of an image provided from the top camera may overlap with the top portion of an image provided from the bottom camera. The stereo pairs may then be arranged similar to the individual cameras described above. In particular, each stereo pair may overlap with one or more other stereo pairs to provide a robotic device with a 360 field of view. For example, four cameras, each with a horizontal field of view of greater than 180 degrees may be arranged as two cameras organized vertically in pairs, where each vertically aligned pair has the same horizontal field of view of 180 degrees as the individual cameras. Each pair of cameras may then be arranged to point to opposing ends of the surroundings and provide depth images having overlapping vertical edges with one or more other pairs. Accordingly, the four cameras arranged in two stereo pairs may have a field of view of 360 degrees horizontally. Other above mentioned geometries involving individual cameras may likewise use stereo pairs of cameras in a similar way.

The area of vertical edge overlaps, and horizontal edge overlaps in the case of stereo pairs, may vary depending on the geometry and the field of view of the sensors. Generally, increased overlap may result in more accurate depth perception, among other advantages. Thus, an arrangement of vertical stereo pairs of cameras may provide more accurate depth perception than an arrangement of cameras with only vertical edge overlaps.

The static sensor arrangement may be used to obtain an overview of the surroundings of the robotic device. A robotic device may employ a moveable sensor arrangement to provide for a higher resolution observation of a specific portion of the surroundings. The moveable sensor arrangement may comprise at least one moveable camera on the mobile robotic device. The at least one moveable camera on the mobile robotic device may have a smaller field of view and a higher angular resolution than the static sensor arrangement. In some examples, the moveable camera may be an RGB camera. In further examples, the moveable sensor arrangement may be on an end of arm component of a robotic device. The end of arm component may further comprise an illumination source.

In some applications, the static sensor arrangement may be used to monitor the surroundings of the robotic device and provide information on any changes. The moveable sensor arrangement may be used to obtain more specific and detailed information on the surroundings. For instance, the robotic device may be asked to hand an object, e.g. a book, on a table to a person in the process of walking. The static sensor arrangement may be used to obtain general information on the location of the book and the location of the person in the surroundings. The moveable sensor arrangement, which may be on the end of arm component of a robotic device, may move alone or in conjunction with other movements of the robotic device to observe the book in more detail. The end of arm component may then move to pick up the book and move towards the person in the process of walking. The static sensor arrangement having a 360 degree field of view may be used to continuously observe the movement of the person. The robotic device may then move towards the updated position of the person to hand the person the book.

In some examples, the static sensor arrangement with a 360 horizontal field of view may monitor the surroundings, but intermittently offload the higher resolution imaging and functionality to the moveable sensor arrangement of the robotic device. For instance, when the robot is tasked with picking up an object, data from the static sensor arrangement is analyzed for the presence of such an object. The arm of the robotic device may be controlled to approach the object so that the moveable sensor arrangement may observe the object in more detail. This hybrid resolution sensing system may be more efficient than a system with only a moveable sensor arrangement.

### II. Example Robotic Systems

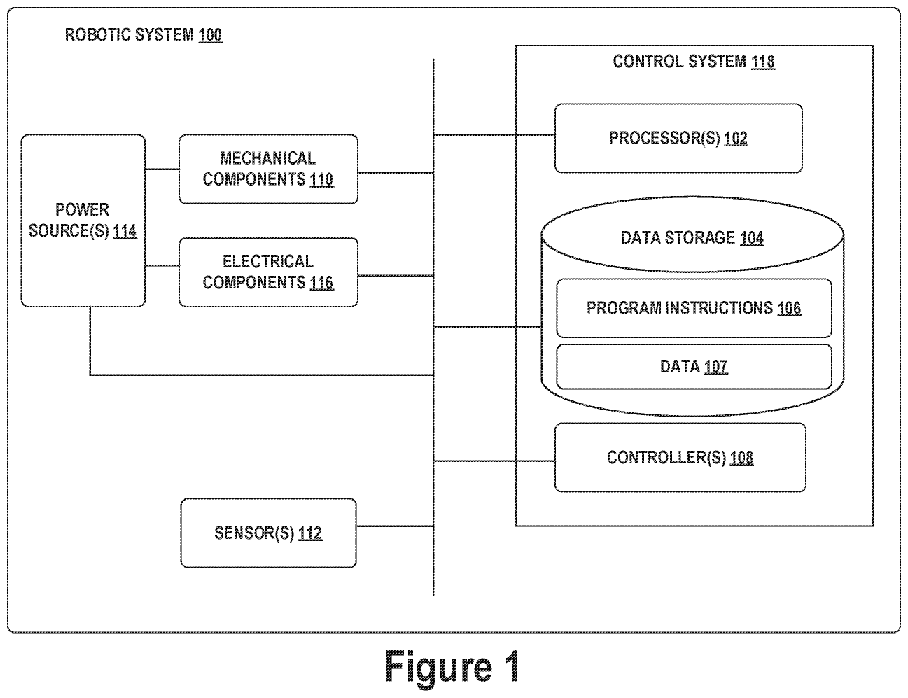

FIG. 1 illustrates an example configuration of a robotic system that may be used in connection with the implementations described herein. Robotic system 100 may be configured to operate autonomously, semi-autonomously, or using directions provided by user(s). Robotic system 100 may be implemented in various forms, such as a robotic arm, industrial robot, or some other arrangement. Some example implementations involve a robotic system 100 engineered to be low cost at scale and designed to support a variety of tasks. Robotic system 100 may be designed to be capable of operating around people. Robotic system 100 may also be optimized for machine learning. Throughout this description, robotic system 100 may also be referred to as a robot, robotic device, or mobile robot, among other designations.

As shown in FIG. 1, robotic system 100 may include processor(s) 102, data storage 104, and controller(s) 108, which together may be part of control system 118. Robotic system 100 may also include sensor(s) 112, power source(s) 114, mechanical components 110, and electrical components 116. Nonetheless, robotic system 100 is shown for illustrative purposes, and may include more or fewer components. The various components of robotic system 100 may be connected in any manner, including wired or wireless connections. Further, in some examples, components of robotic system 100 may be distributed among multiple physical entities rather than a single physical entity. Other example illustrations of robotic system 100 may exist as well.

Processor(s) 102 may operate as one or more general-purpose hardware processors or special purpose hardware processors (e.g., digital signal processors, application specific integrated circuits, etc.). Processor(s) 102 may be configured to execute computer-readable program instructions 106, and manipulate data 107, both of which are stored in data storage 104. Processor(s) 102 may also directly or indirectly interact with other components of robotic system 100, such as sensor(s) 112, power source(s) 114, mechanical components 110, or electrical components 116.

Data storage 104 may be one or more types of hardware memory. For example, data storage 104 may include or take the form of one or more computer-readable storage media that can be read or accessed by processor(s) 102. The one or more computer-readable storage media can include volatile or non-volatile storage components, such as optical, magnetic, organic, or another type of memory or storage, which can be integrated in whole or in part with processor(s) 102. In some implementations, data storage 104 can be a single physical device. In other implementations, data storage 104 can be implemented using two or more physical devices, which may communicate with one another via wired or wireless communication. As noted previously, data storage 104 may include the computer-readable program instructions 106 and data 107. Data 107 may be any type of data, such as configuration data, sensor data, or diagnostic data, among other possibilities.

Controller 108 may include one or more electrical circuits, units of digital logic, computer chips, or microprocessors that are configured to (perhaps among other tasks), interface between any combination of mechanical components 110, sensor(s) 112, power source(s) 114, electrical components 116, control system 118, or a user of robotic system 100. In some implementations, controller 108 may be a purpose-built embedded device for performing specific operations with one or more subsystems of the robotic system 100.

Control system 118 may monitor and physically change the operating conditions of robotic system 100. In doing so, control system 118 may serve as a link between portions of robotic system 100, such as between mechanical components 110 or electrical components 116. In some instances, control system 118 may serve as an interface between robotic system 100 and another computing device. Further, control system 118 may serve as an interface between robotic system 100 and a user. In some instances, control system 118 may include various components for communicating with robotic system 100, including a joystick, buttons, or ports, etc. The example interfaces and communications noted above may be implemented via a wired or wireless connection, or both. Control system 118 may perform other operations for robotic system 100 as well.

During operation, control system 118 may communicate with other systems of robotic system 100 via wired or wireless connections, and may further be configured to communicate with one or more users of the robot. As one possible illustration, control system 118 may receive an input (e.g., from a user or from another robot) indicating an instruction to perform a requested task, such as to pick up and move an object from one location to another location. Based on this input, control system 118 may perform operations to cause the robotic system 100 to make a sequence of movements to perform the requested task. As another illustration, a control system may receive an input indicating an instruction to move to a requested location. In response, control system 118 (perhaps with the assistance of other components or systems) may determine a direction and speed to move robotic system 100 through an environment en route to the requested location.

Operations of control system 118 may be carried out by processor(s) 102. Alternatively, these operations may be carried out by controller(s) 108, or a combination of processor(s) 102 and controller(s) 108. In some implementations, control system 118 may partially or wholly reside on a device other than robotic system 100, and therefore may at least in part control robotic system 100 remotely.

Mechanical components 110 represent hardware of robotic system 100 that may enable robotic system 100 to perform physical operations. As a few examples, robotic system 100 may include one or more physical members, such as an arm, an end effector, a head, a neck, a torso, a base, and wheels. The physical members or other parts of robotic system 100 may further include actuators arranged to move the physical members in relation to one another. Robotic system 100 may also include one or more structured bodies for housing control system 118 or other components, and may further include other types of mechanical components. The particular mechanical components 110 used in a given robot may vary based on the design of the robot, and may also be based on the operations or tasks the robot may be configured to perform.

In some examples, mechanical components 110 may include one or more removable components. Robotic system 100 may be configured to add or remove such removable components, which may involve assistance from a user or another robot. For example, robotic system 100 may be configured with removable end effectors or digits that can be replaced or changed as needed or desired. In some implementations, robotic system 100 may include one or more removable or replaceable battery units, control systems, power systems, bumpers, or sensors. Other types of removable components may be included within some implementations.

Robotic system 100 may include sensor(s) 112 arranged to sense aspects of robotic system 100. Sensor(s) 112 may include one or more force sensors, torque sensors, velocity sensors, acceleration sensors, position sensors, proximity sensors, motion sensors, location sensors, load sensors, temperature sensors, touch sensors, depth sensors, ultrasonic range sensors, infrared sensors, object sensors, or cameras, among other possibilities. Within some examples, robotic system 100 may be configured to receive sensor data from sensors that are physically separated from the robot (e.g., sensors that are positioned on other robots or located within the environment in which the robot is operating).

Sensor(s) 112 may provide sensor data to processor(s) 102 (perhaps by way of data 107) to allow for interaction of robotic system 100 with its environment, as well as monitoring of the operation of robotic system 100. The sensor data may be used in evaluation of various factors for activation, movement, and deactivation of mechanical components 110 and electrical components 116 by control system 118. For example, sensor(s) 112 may capture data corresponding to the terrain of the environment or location of nearby objects, which may assist with environment recognition and navigation.

In some examples, sensor(s) 112 may include RADAR (e.g., for long-range object detection, distance determination, or speed determination), LIDAR (e.g., for short-range object detection, distance determination, or speed determination), SONAR (e.g., for underwater object detection, distance determination, or speed determination), VICON® (e.g., for motion capture), one or more cameras (e.g., stereoscopic cameras for 3D vision), a global positioning system (GPS) transceiver, or other sensors for capturing information of the environment in which robotic system 100 is operating. Sensor(s) 112 may monitor the environment in real time, and detect obstacles, elements of the terrain, weather conditions, temperature, or other aspects of the environment. In another example, sensor(s) 112 may capture data corresponding to one or more characteristics of a target or identified object, such as a size, shape, profile, structure, or orientation of the object.

Further, robotic system 100 may include sensor(s) 112 configured to receive information indicative of the state of robotic system 100, including sensor(s) 112 that may monitor the state of the various components of robotic system 100. Sensor(s) 112 may measure activity of systems of robotic system 100 and receive information based on the operation of the various features of robotic system 100, such as the operation of an extendable arm, an end effector, or other mechanical or electrical features of robotic system 100. The data provided by sensor(s) 112 may enable control system 118 to determine errors in operation as well as monitor overall operation of components of robotic system 100.

As an example, robotic system 100 may use force/torque sensors to measure load on various components of robotic system 100. In some implementations, robotic system 100 may include one or more force/torque sensors on an arm or end effector to measure the load on the actuators that move one or more members of the arm or end effector. In some examples, the robotic system 100 may include a force/torque sensor at or near the wrist or end effector, but not at or near other joints of a robotic arm. In further examples, robotic system 100 may use one or more position sensors to sense the position of the actuators of the robotic system. For instance, such position sensors may sense states of extension, retraction, positioning, or rotation of the actuators on an arm or end effector.

As another example, sensor(s) 112 may include one or more velocity or acceleration sensors. For instance, sensor(s) 112 may include an inertial measurement unit (IMU). The IMU may sense velocity and acceleration in the world frame, with respect to the gravity vector. The velocity and acceleration sensed by the IMU may then be translated to that of robotic system 100 based on the location of the IMU in robotic system 100 and the kinematics of robotic system 100.

Robotic system 100 may include other types of sensors not explicitly discussed herein. Additionally or alternatively, the robotic system may use particular sensors for purposes not enumerated herein.

Robotic system 100 may also include one or more power source(s) 114 configured to supply power to various components of robotic system 100. Among other possible power systems, robotic system 100 may include a hydraulic system, electrical system, batteries, or other types of power systems. As an example illustration, robotic system 100 may include one or more batteries configured to provide charge to components of robotic system 100. Some of mechanical components 110 or electrical components 116 may each connect to a different power source, may be powered by the same power source, or be powered by multiple power sources.

Any type of power source may be used to power robotic system 100, such as electrical power or a gasoline engine. Additionally or alternatively, robotic system 100 may include a hydraulic system configured to provide power to mechanical components 110 using fluid power. Components of robotic system 100 may operate based on hydraulic fluid being transmitted throughout the hydraulic system to various hydraulic motors and hydraulic cylinders, for example. The hydraulic system may transfer hydraulic power by way of pressurized hydraulic fluid through tubes, flexible hoses, or other links between components of robotic system 100. Power source(s) 114 may charge using various types of charging, such as wired connections to an outside power source, wireless charging, combustion, or other examples.

Electrical components 116 may include various mechanisms capable of processing, transferring, or providing electrical charge or electric signals. Among possible examples, electrical components 116 may include electrical wires, circuitry, or wireless communication transmitters and receivers to enable operations of robotic system 100. Electrical components 116 may interwork with mechanical components 110 to enable robotic system 100 to perform various operations. Electrical components 116 may be configured to provide power from power source(s) 114 to the various mechanical components 110, for example. Further, robotic system 100 may include electric motors. Other examples of electrical components 116 may exist as well.

Robotic system 100 may include a body, which may connect to or house appendages and components of the robotic system. As such, the structure of the body may vary within examples and may further depend on particular operations that a given robot may have been designed to perform. For example, a robot developed to carry heavy loads may have a wide body that enables placement of the load. Similarly, a robot designed to operate in tight spaces may have a relatively tall, narrow body. Further, the body or the other components may be developed using various types of materials, such as metals or plastics. Within other examples, a robot may have a body with a different structure or made of various types of materials.

The body or the other components may include or carry sensor(s) 112. These sensors may be positioned in various locations on the robotic system 100, such as on a body, a head, a neck, a base, a torso, an arm, or an end effector, among other examples.

Robotic system 100 may be configured to carry a load, such as a type of cargo that is to be transported. In some examples, the load may be placed by the robotic system 100 into a bin or other container attached to the robotic system 100. The load may also represent external batteries or other types of power sources (e.g., solar panels) that the robotic system 100 may utilize. Carrying the load represents one example use for which the robotic system 100 may be configured, but the robotic system 100 may be configured to perform other operations as well.

As noted above, robotic system 100 may include various types of appendages, wheels, end effectors, gripping devices and so on. In some examples, robotic system 100 may include a mobile base with wheels, treads, or some other form of locomotion. Additionally, robotic system 100 may include a robotic arm or some other form of robotic manipulator. In the case of a mobile base, the base may be considered as one of mechanical components 110 and may include wheels, powered by one or more of actuators, which allow for mobility of a robotic arm in addition to the rest of the body.

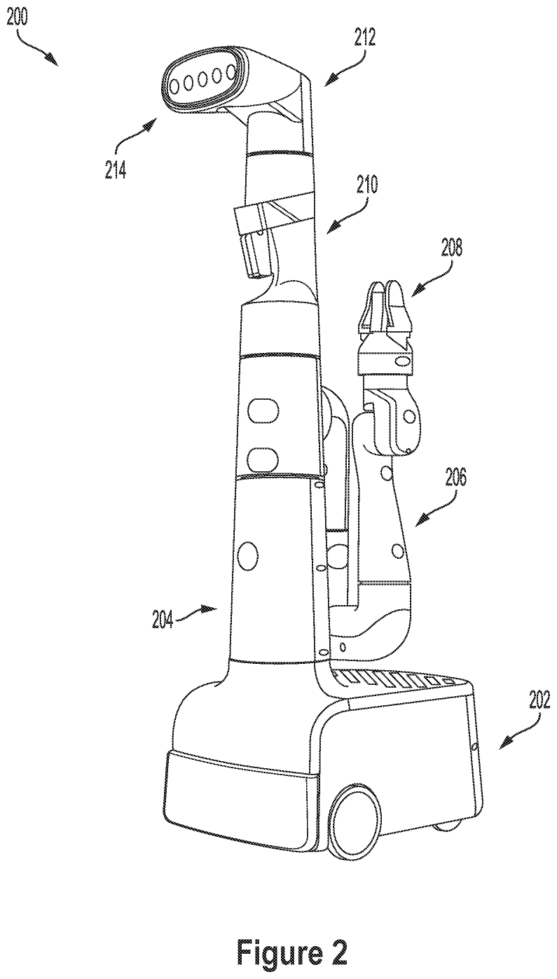

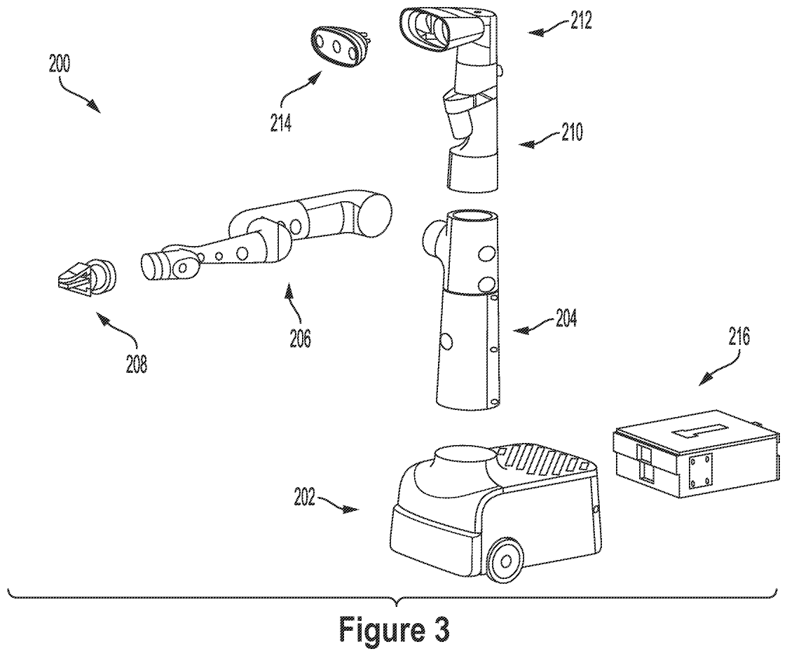

FIG. 2 illustrates a mobile robot, in accordance with example embodiments. FIG. 3 illustrates an exploded view of the mobile robot, in accordance with example embodiments. More specifically, a robot 200 may include a mobile base 202, a midsection 204, an arm 206, an end-of-arm system (EOAS) 208, a mast 210, a perception housing 212, and a perception suite 214. The robot 200 may also include a compute box 216 stored within mobile base 202.

The mobile base 202 includes two drive wheels positioned at a front end of the robot 200 in order to provide locomotion to robot 200. The mobile base 202 also includes additional casters (not shown) to facilitate motion of the mobile base 202 over a ground surface. The mobile base 202 may have a modular architecture that allows compute box 216 to be easily removed. Compute box 216 may serve as a removable control system for robot 200 (rather than a mechanically integrated control system). After removing external shells, the compute box 216 can be easily removed and/or replaced. The mobile base 202 may also be designed to allow for additional modularity. For example, the mobile base 202 may also be designed so that a power system, a battery, and/or external bumpers can all be easily removed and/or replaced.

The midsection 204 may be attached to the mobile base 202 at a front end of the mobile base 202. The midsection 204 includes a mounting column which is fixed to the mobile base 202. The midsection 204 additionally includes a rotational joint for arm 206. More specifically, the midsection 204 includes the first two degrees of freedom for arm 206 (a shoulder yaw J0 joint and a shoulder pitch J1 joint). The mounting column and the shoulder yaw J0 joint may form a portion of a stacked tower at the front of mobile base 202. The mounting column and the shoulder yaw J0 joint may be coaxial. The length of the mounting column of midsection 204 may be chosen to provide the arm 206 with sufficient height to perform manipulation tasks at commonly encountered height levels (e.g., coffee table top and counter top levels). The length of the mounting column of midsection 204 may also allow the shoulder pitch J1 joint to rotate the arm 206 over the mobile base 202 without contacting the mobile base 202.

The arm 206 may be a 7DOF robotic arm when connected to the midsection 204. As noted, the first two DOFs of the arm 206 may be included in the midsection 204. The remaining five DOFs may be included in a standalone section of the arm 206 as illustrated in FIGS. 2 and 3. The arm 206 may be made up of plastic monolithic link structures. Inside the arm 206 may be housed standalone actuator modules, local motor drivers, and thru bore cabling.

The EOAS 208 may be an end effector at the end of arm 206. EWAS 208 may allow the robot 200 to manipulate objects in the environment. As shown in FIGS. 2 and 3, EOAS 208 may be a gripper, such as an underactuated pinch gripper. The gripper may include one or more contact sensors such as force/torque sensors and/or non-contact sensors such as one or more cameras to facilitate object detection and gripper control. EOAS 208 may also be a different type of gripper such as a suction gripper or a different type of tool such as a drill or a brush. EOAS 208 may also be swappable or include swappable components such as gripper digits.

The mast 210 may be a relatively long, narrow component between the shoulder yaw J0 joint for arm 206 and perception housing 212. The mast 210 may be part of the stacked tower at the front of mobile base 202. The mast 210 may be fixed relative to the mobile base 202. The mast 210 may be coaxial with the midsection 204. The length of the mast 210 may facilitate perception by perception suite 214 of objects being manipulated by EOAS 208. The mast 210 may have a length such that when the shoulder pitch J1 joint is rotated vertical up, a topmost point of a bicep of the arm 206 is approximately aligned with a top of the mast 210. The length of the mast 210 may then be sufficient to prevent a collision between the perception housing 212 and the arm 206 when the shoulder pitch J1 joint is rotated vertical up.

As shown in FIGS. 2 and 3, the mast 210 may include a 3D lidar sensor configured to collect depth information about the environment. The 3D lidar sensor may be coupled to a carved-out portion of the mast 210 and fixed at a downward angle. The lidar position may be optimized for localization, navigation, and for front cliff detection.

The perception housing 212 may include at least one sensor making up perception suite 214. The perception housing 212 may be connected to a pan/tilt control to allow for reorienting of the perception housing 212 (e.g., to view objects being manipulated by EOAS 208). The perception housing 212 may be a part of the stacked tower fixed to the mobile base 202. A rear portion of the perception housing 212 may be coaxial with the mast 210.

The perception suite 214 may include a suite of sensors configured to collect sensor data representative of the environment of the robot 200. The perception suite 214 may include an infrared (IR)-assisted stereo depth sensor. The perception suite 214 may additionally include a wide-angled red-green-blue (RGB) camera for human-robot interaction and context information. The perception suite 214 may additionally include a high resolution RGB camera for object classification. A face light ring surrounding the perception suite 214 may also be included for improved human-robot interaction and scene illumination. In some examples, the perception suite 214 may also include a projector configured to project images and/or video into the environment.

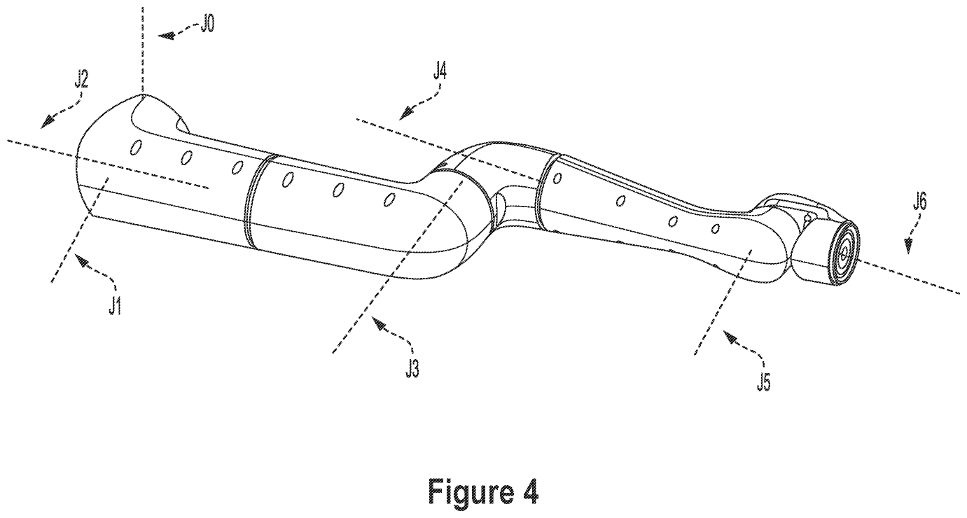

FIG. 4 illustrates a robotic arm, in accordance with example embodiments. The robotic arm includes 7 DOFs: a shoulder yaw J0 joint, a shoulder pitch J1 joint, a bicep roll J2 joint, an elbow pitch J3 joint, a forearm roll J4 joint, a wrist pitch J5 joint, and wrist roll J6 joint. Each of the joints may be coupled to one or more actuators. The actuators coupled to the joints may be operable to cause movement of links down the kinematic chain (as well as any end effector attached to the robot arm).

The shoulder yaw J0 joint allows the robot arm to rotate toward the front and toward the back of the robot. One beneficial use of this motion is to allow the robot to pick up an object in front of the robot and quickly place the object on the rear section of the robot (as well as the reverse motion). Another beneficial use of this motion is to quickly move the robot arm from a stowed configuration behind the robot to an active position in front of the robot (as well as the reverse motion).

The shoulder pitch J1 joint allows the robot to lift the robot arm (e.g., so that the bicep is up to perception suite level on the robot) and to lower the robot arm (e.g., so that the bicep is just above the mobile base). This motion is beneficial to allow the robot to efficiently perform manipulation operations (e.g., top grasps and side grasps) at different target height levels in the environment. For instance, the shoulder pitch J1 joint may be rotated to a vertical up position to allow the robot to easily manipulate objects on a table in the environment. The shoulder pitch J1 joint may be rotated to a vertical down position to allow the robot to easily manipulate objects on a ground surface in the environment.

The bicep roll J2 joint allows the robot to rotate the bicep to move the elbow and forearm relative to the bicep. This motion may be particularly beneficial for facilitating a clear view of the EOAS by the robot's perception suite. By rotating the bicep roll J2 joint, the robot may kick out the elbow and forearm to improve line of sight to an object held in a gripper of the robot.

Moving down the kinematic chain, alternating pitch and roll joints (a shoulder pitch J1 joint, a bicep roll J2 joint, an elbow pitch J3 joint, a forearm roll J4 joint, a wrist pitch J5 joint, and wrist roll J6 joint) are provided to improve the manipulability of the robotic arm. The axes of the wrist pitch J5 joint, the wrist roll J6 joint, and the forearm roll J4 joint are intersecting for reduced arm motion to reorient objects. The wrist roll J6 point is provided instead of two pitch joints in the wrist in order to improve object rotation.

In some examples, a robotic arm such as the one illustrated in FIG. 4 may be capable of operating in a teach mode. In particular, teach mode may be an operating mode of the robotic arm that allows a user to physically interact with and guide robotic arm towards carrying out and recording various movements. In a teaching mode, an external force is applied (e.g., by the user) to the robotic arm based on a teaching input that is intended to teach the robot regarding how to carry out a specific task. The robotic arm may thus obtain data regarding how to carry out the specific task based on instructions and guidance from the user. Such data may relate to a plurality of configurations of mechanical components, joint position data, velocity data, acceleration data, torque data, force data, and power data, among other possibilities.

During teach mode the user may grasp onto the EOAS or wrist in some examples or onto any part of robotic arm in other examples, and provide an external force by physically moving robotic arm. In particular, the user may guide the robotic arm towards grasping onto an object and then moving the object from a first location to a second location. As the user guides the robotic arm during teach mode, the robot may obtain and record data related to the movement such that the robotic arm may be configured to independently carry out the task at a future time during independent operation (e.g., when the robotic arm operates independently outside of teach mode). In some examples, external forces may also be applied by other entities in the physical workspace such as by other objects, machines, or robotic systems, among other possibilities.

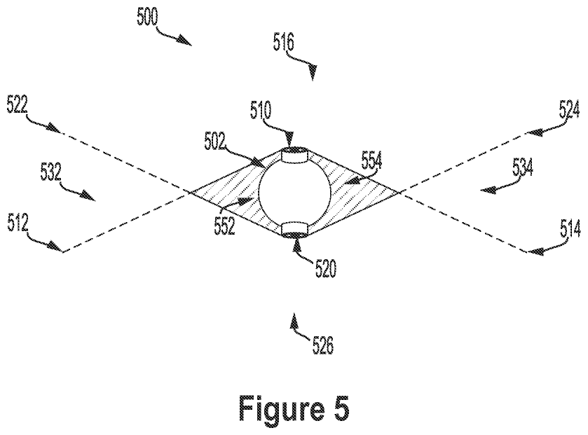

As mentioned above, a robotic device, e.g. robot 200, may be configured to have a fixed perception component. The fixed perception component may include a static sensor arrangement which may involve at least two fixed cameras, where the cameras have a combined 360 degree horizontal field of view around the robotic device. FIG. 5 illustrates static sensor arrangement 500 involving two cameras, in accordance with example embodiments. Other examples of static sensor arrangements are also possible.

Static sensor arrangement 500 on fixed perception component 502 may involve camera 510 and camera 520, the two cameras having properties and arranged in a manner to facilitate the system having a combined 360 degree horizontal field of view a certain distance from fixed perception component 502. The 360 degree horizontal field of view may be formed by the fields of view of camera 510 and camera 520.

Camera 510 and camera 520 individually may have similar horizontal fields of view numerically and are arranged on opposite ends of fixed perception component 502. Camera 510 may have a field of view outlined by line 512 and line 514, covering regions 532, 516, and 534. Camera 520 may have a field of view outlined by line 522 and line 524, covering regions 532, 526, and 534. Accordingly, region 532 and region 534 may be an overlapping field of view for both camera 510 and 520, whereas region 516 may only be in the field of view of camera 510 and region 526 may only be in the field of view of camera 520.

Region 532 and region 534 of overlapping fields of view may differ based on the field of view of each camera. Sensor arrangements with smaller fields of view may have less overlap. More overlap may result in higher proportions of an image being repeated from image to image, in particular as objects in the environment are farther away from the robotic device, and may lead to increased unnecessary processing due to the higher proportions of repeat regions. In contrast, more overlap may also facilitate improved depth perception, which may be beneficial to the robotic device in applications. Less overlap may result in larger blind regions in proximity to static sensor arrangement 500, as described in following sections.

In combining the field of view of camera 510 with the field of view of camera 520, there may be regions where a 360 degree horizontal field of view is not achieved, for example blind spot region 552 outlined by line 512 and line 522 and blind spot region 554 outlined by line 514 and line 524. Blind spot regions 552 and 554 may be minimized by larger fields of view of cameras 510 and 520. Alternatively, individual blind spot regions may be reduced in size by increasing the number of cameras with the same or larger numerical field of view (and perhaps in some cases, a smaller field of view). Still alternatively, individual blind spot regions may be reduced by decreasing the size of fixed perception component 502 such that each camera is placed closer together. These alternative arrangements for minimizing the blind spot region may apply to any static sensor arrangement, e.g. static sensor arrangement 600 and 700, as discussed in later sections. Nevertheless, most applications of static sensor arrangement 500 and other static sensor arrangements may be on a fixed perception component to observe the environment of the robotic device at large, such that nearby observations involving blind spot regions such as regions 552 and 554 may not be necessary.

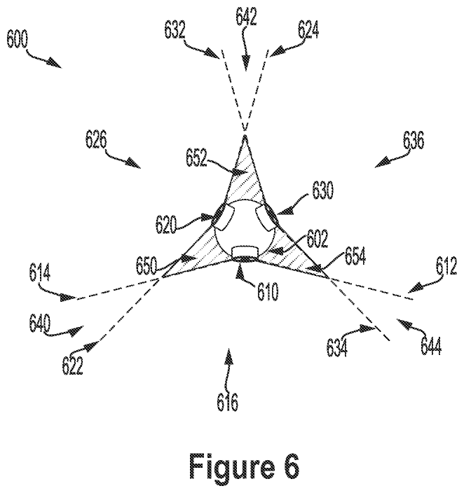

FIG. 6 is another example of a static sensor arrangement, in accordance with example embodiments. Static sensor arrangement 600 involves camera 610, camera 620, and camera 630 on fixed perception component 602. Each camera may have a respective field of view able to be arranged in a manner to facilitate the system having a combined 360 degree horizontal field of view a certain distance from fixed perception component 602.

In the case of static sensor arrangement 600, each camera is evenly spaced with approximately the same numerical field of view. Similar to static sensor arrangement 500, camera 610 may have a field of view outlined by lines 612 and 614, encompassing regions 640, 616, and 644. Camera 620 may have a field of view outlined by lines 622 and 624, encompassing regions 640, 626, and 642. Camera 630 may have a field of view outlined by lines 632 and 634, encompassing regions 642, 636, and 644. Accordingly, regions 640, 642, and 644 may be overlapping fields of view for at least two cameras.

Regions 640, 642, and 644 of overlapping fields of view may differ based on the field of view of each camera, similar to static sensor arrangement 600. Due to the increased number of cameras and smaller fields of view of each camera, the individual overlapping fields of view may generally be smaller compared to static sensor arrangement 500. However, as mentioned above, the individual overlapping fields of view may be larger or smaller based on the individual fields of view of the camera. More overlap may facilitate repeated images of areas which may improve depth perception and/or lead to more unnecessary processing, whereas less overlap may create larger blind spots closer to static sensor arrangement 600.

Similar to static sensor arrangement 500, static sensor arrangement 600 may also have regions where a 360 degree field of view is not achieved, for example blind spot region 650 outlined by lines 614 and 622, blind spot region 652 outlined by lines 624 and 632, and blind spot region 654 outlined by lines 612 and 634. Blind spot region 650 may be minimized by increasing and/or moving the fields of view of camera 610 and 620. Similarly, blind spot region 652 may be minimized by increasing and/or moving the fields of view of cameras 620 and 630 and blind spot region 654 may be minimized by increasing and/or moving the fields of view of cameras 610 and 630. These changes in static sensor arrangement 600 may also affect the size of the regions of overlapping fields of view.

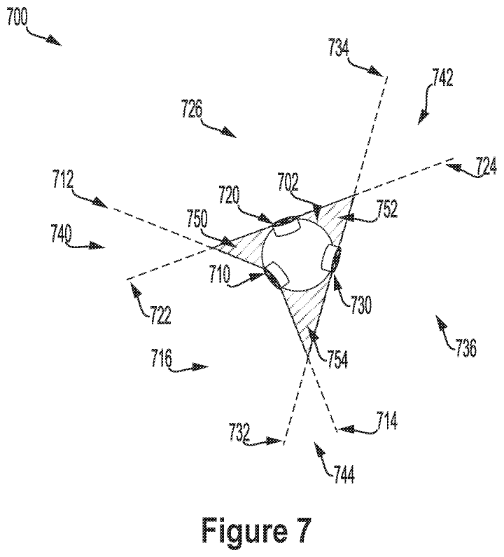

FIG. 7 illustrates static sensor arrangement 700 involving three cameras, in accordance with example embodiments. Static sensor arrangement 700 involves camera 710, camera 720, and camera 730 on fixed perception component 702. In contrast to static sensor arrangement 600, static sensor arrangement involves cameras with differing numerical fields of view in an asymmetrical distribution but nevertheless achieving a 360 degree horizontal field of view.

In the case of static sensor arrangement 700, camera 720 and camera 730 have similar fields of view, while camera 710 has a smaller field of view. The field of view of camera 720 is outlined by lines 722 and 724, encompassing regions 740, 726, and 742 and the field of view of camera 730 is outlined by lines 732 and 734, encompassing regions 742, 736, and 744. The field of view of camera 710 is outlined by lines 712 and 714, encompassing regions 740, 716, and 744. Regions 740, 742, and 744 may be within the fields of view of multiple cameras, i.e. cameras 710, 720, and 720, and these regions 740, 742, and 744 of overlapping fields of view may differ in size.

Similar to above examples of static sensor arrangements 500 and 600, static sensor arrangement 700 may also have blind spot regions. However, blind spot regions may differ in size and shape. For example, blind spot region 750 outlined by lines 712 and 722 may be smaller than blind spot region 754 outlined by lines 714 and 732. Both blind spot regions may differ in shape from each other and from blind spot region 752, outlined by lines 724 and 734.

Static sensor arrangements 500, 600, and 700 may be advantageous in several situations. Due to the 360 horizontal field of view, the arrangements may be useful in situations where robot autonomy is preferred since many aspects of the surroundings may be almost continuously observed. Further, the arrangements may facilitate streamlined data collection due to the absence of the need to move components for data collection of the surroundings. Due to the use of multiple cameras, static sensor arrangements may also receive images with relatively high angular resolution and minimal distortion.

Static sensor arrangements 500, 600, and 700 are examples of some arrangements and are not meant to be limiting. Other possibilities exist. For example, there may be arrangements with more cameras, arrangements with cameras of lesser or greater fields of view, arrangements of cameras with large fields of view such that blind spot regions near each camera are much less prevalent to the extent that they may be hardly noticeable, among many others.

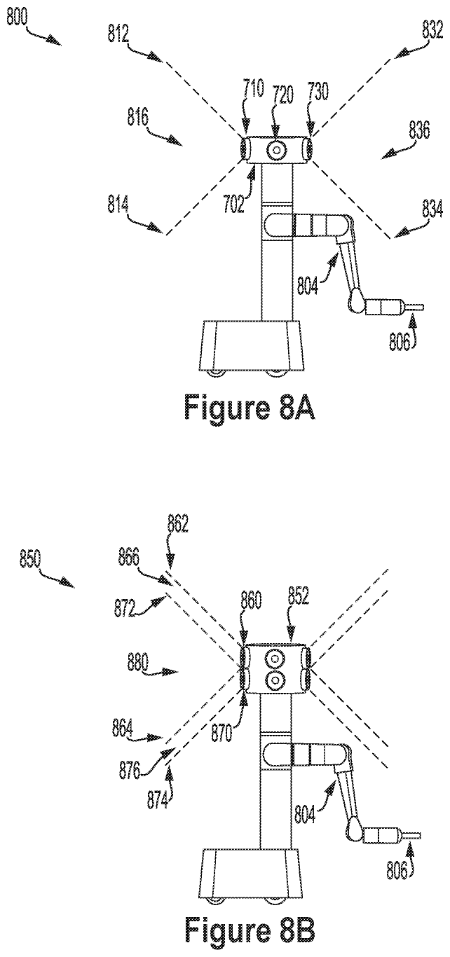

FIG. 8A is a side view of a robotic device, in accordance with example embodiments. Robotic device 800 may include a static sensor arrangement with three cameras, perhaps static sensor arrangement 700 for the purposes of example. Robotic device 800 may also involve robotic arm 804 and end of arm perception 806, which may contain a camera with less than 360 degree horizontal field of view.

As stated above, static sensor arrangement 700 involves fixed perception component 702 and cameras 710, 720, and 730, which may have a combined 360 degree horizontal field of view. However, the vertical field of view of each cameras 710, 720, and 730 may be less than 360 degrees, but nevertheless sufficient to cover the area of interest around the robot. For example, the vertical field of view of camera 710 may be outlined by line 812 and line 814, covering region 816. Vertical field of view of camera 730 may be outlined by line 832 and line 834, covering region 836. The vertical field of view of camera 720 is not shown but may be similar to the vertical fields of view of cameras 710 and 730. Although the vertical fields of view of cameras 710 and 730 are similar in this example, they may not necessarily be similar and each camera may have a smaller or larger vertical field of view, depending on what is practical and feasible in the application and manufacturing. In some applications, the field of view of cameras 710, 720, and 730 may be sufficient to cover from the floor on which the robotic device rests to around 30 degrees above the horizon for a total vertical field of view of around 120 degrees.

FIG. 8B is a side view of a robotic device with a fixed perception component including stereo pairs of cameras, in accordance with example embodiments. Fixed perception component 852 may have two sets of cameras, each of which may be arranged similar to static sensor arrangement 700, for example, and a top view of fixed perception component 852 may nevertheless be similar to static sensor arrangement 700 on fixed perception component 702. Each set of cameras may be stacked such that each camera has a vertical partner, for example camera 860 with camera 870. For simplicity, other cameras on fixed perception component 852 are not described, but it may be assumed that each stereo pair has similar properties as camera 860 and camera 870.

Camera 860 and camera 870 may have overlapping fields of view. Camera 860 may have a field of view outlined by line 862 and line 864, encompassing regions 866 and 880. Camera 870 may have a field of view outlined by line 872 and line 874, encompassing regions 880 and 876. Accordingly, cameras 860 and 870 may have overlapping fields of view at region 880.

As mentioned above, the vertical stereo pairs of cameras (in this case camera 860 and camera 870) may facilitate more accurate depth perception in addition to extending the vertical field of view of the robotic device. As such, robotic device 850 incorporating fixed perception component 852 may have more accurate depth perception compared to robotic device 800 with fixed perception component 702 and as illustrated, robotic device 850 may have a larger vertical field of view in comparison to robotic device 800. Robotic device 850 may additionally incorporate more layers of cameras arranged in accordance with static sensor arrangement 700 to create additional overlap and a wider vertical field of view. Additionally, each camera in the vertical pair of cameras may be spaced further apart such that the vertical field of view is greater and the overlap between the fields of view (e.g. region 880) is decreased.

Robotic device 800 and robotic device 850 may incorporate one example each of static sensor arrangements, but many other examples are also possible. Robotic device 800 may incorporate any of static sensor arrangement 500, static sensor arrangement 600, static sensor arrangement 700, and many others. Robotic device 850 may similarly incorporate any of static sensor arrangement 500, static sensor arrangement 600, static sensor arrangement 700, and many others in an arrangement that incorporates each respective camera in the static sensor arrangement in stereo pairs.

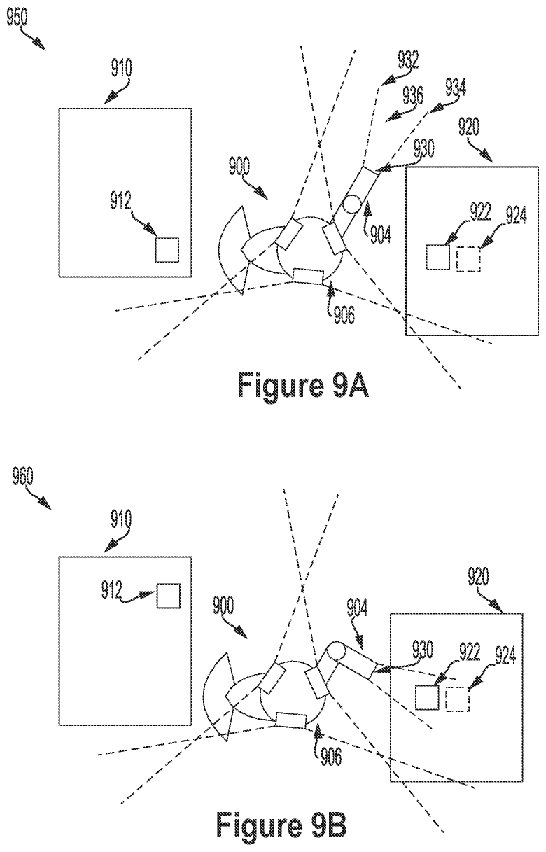

FIG. 9A is a top view of a robotic device in an environment, in accordance with example embodiments. In arrangement 950, robotic device 900 may have fixed perception component 906 with a similar static sensor arrangement to static sensor arrangement 600. Robotic device 900 may additionally have an end of arm component 904 containing camera 930 with horizontal field of view outlined by line 932 and line 934, encompassing region 936. The environment may contain table 920 and object 922 on top of table 920, along with table 910 and object 912 on top of table 910.

FIG. 9B is a top view of a robotic device in an environment, in accordance with example embodiments. It may be observed that robotic device 900 of arrangement 950 is similar to robotic device 900 of arrangement 960. However, between arrangement 950 and arrangement 960, object 912 changed locations on table 910 and end of arm component 904 containing camera 930 changed locations.

In both arrangement 950 and arrangement 960, robotic device 900 may have a fixed perception component 906 with a complete 360 degree horizontal field of view, while camera 930 on end of arm component 904 may have a smaller horizontal field of view. Fixed perception component 906 may have sensors of lower resolution to facilitate fast and efficient processing of the data. In contrast, camera 930 on end of arm component 904 may have a higher resolution and be able to observe objects in more detail, since a smaller field of view may immediately imply less intensive processing of data. Accordingly, robotic device 900 may be able to observe an overview of the environment at large from fixed perception component 906, while relying on camera 930 on end of arm component 904 for more detailed observations. In some examples, end of arm component 904 may include multiple cameras, e.g. a stereo pair of cameras similar to FIG. 8B, which may facilitate improved depth perception on the end of arm component. Robotic device 900 may thus also be able to obtain more accurate points in space using data obtained from sensors on end of arm component 904 compared to data obtained from sensors on fixed perception component 906.

In some examples, robotic device 900 in arrangement 950 may be tasked with stacking object 922 on top of object 912. As in arrangement 950, end of arm component 904 may be pointing away from robotic device 900. Robotic device 900 may observe the position of object 922 and object 912 using fixed perception component 906 and determine that object 922 is on table 920 and object 912 is on table 910. Robotic device 900 may subsequently move end of arm component 904 to observe object 922 in more detail (perhaps, to observe the geometry to facilitate a better grip), as in arrangement 960. As robotic device 900 moves end of arm component 904 to observe object 922, a person may move object 912 to a different location on table 910. Robotic device 900, through fixed perception component 906 having a 360 horizontal degree field of view, may be able to recognize that object 912 was moved and the location to which it was moved.

In further examples, object 924 may be present in arrangement 900 and arrangement 950. In arrangement 900, the fixed perception component 906 may be observing the surroundings at large and may perceive the presence of objects 912 and 922, but object 924 may be partially or completely occluded from the view of fixed perception component 906 by object 922. Robotic device 900 may move end of arm component 904 to observe object 922 in more detail and consequently, through sensors on end of arm component 904, detect the presence of object 924 behind object 922.

In still further examples, fixed perception component 906 of robotic device 900 in arrangement 900 and 950 may detect the presence of object 922, but may not be able to classify object 922 or may otherwise need more information regarding object 922. Robotic device 900 may consequently move end of arm component 904 to observe object 922 in further detail and at one or more different angles. In these situations and in other situations, a moveable component, such as end of arm component 904, may be especially advantageous in improving detection and classification processes since a variety of sensor data may be obtained from end of arm component 904 at varying distances and angles.

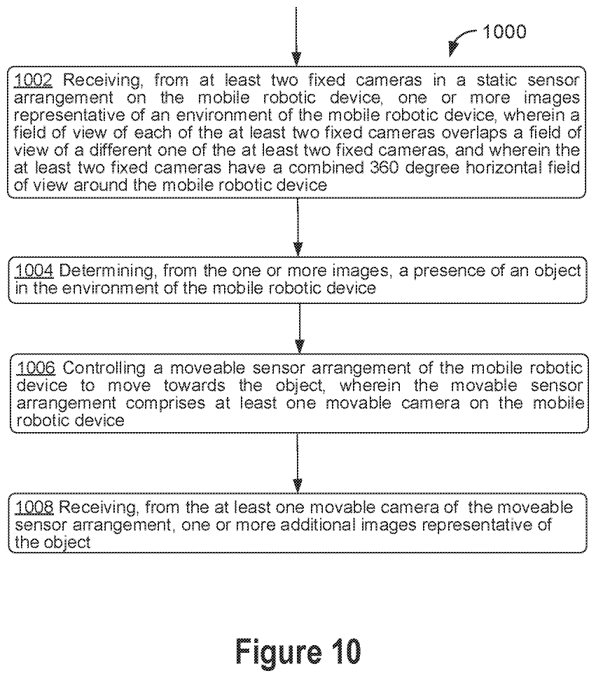

FIG. 10 is a block diagram of a method, in accordance with example embodiments. In some examples, method 1000 of FIG. 10 may be carried out by a control system, such as control system 118 of robotic system 100. In further examples, method 1000 may be carried out by one or more processors, such as processor(s) 102, executing program instructions, such as program instructions 106, stored in a data storage, such as data storage 104. Execution of method 1000 may involve a robotic device, such as the robotic device illustrated and described with respect to FIGS. 1-4, integrated with sensor systems and/or processing methods illustrated by FIGS. 5-9. Other robotic devices may also be used in the performance of method 1000. In further examples, some or all of the blocks of method 1000 may be performed by a control system remote from the robotic device. In yet further examples, different blocks of method 1000 may be performed by different control systems, located on and/or remote from a robotic device.

At block 1002, method 1000 includes receiving, from at least two fixed cameras in a static sensor arrangement on the mobile robotic device, one or more images representative of an environment of the mobile robotic device. The field of view of each of the at least two fixed cameras may overlap a field of view of a different one of the at least two fixed cameras and the at least two fixed cameras may have a combined 360 degree horizontal field of view around the mobile robotic device. The static sensor arrangement may be on a fixed perception component of the robotic device, and each camera may be able to obtain an image of a portion of the environment. In other examples, pairs of cameras may be aligned such that the vertical horizontal field of view of each camera overlaps, creating a stereo pair for better depth perception. These arrangements may require double the number of cameras previously necessary to achieve a 360 degree horizontal field of view. Similar arrangements may be made with triplets, quadruplets, and other numbers of cameras stacked on top of each other.

At block 1004, method 1000 includes determining, from the one or more images, a presence of an object in the environment of the mobile robotic device. In some examples, images received from the cameras may be digitally combined to reconstruct a panoramic image of the environment. The reconstructed image may be the input to an algorithm or a model, e.g. a pre-trained machine learning model, to determine the presence of an object. In other examples, the images without reconstruction may be used in a similar manner to determine the presence of an object in the environment.

At block 1006, method 1000 includes controlling a moveable sensor arrangement of the mobile robotic device to move towards the object. The moveable sensor arrangement may comprise at least one moveable camera on the mobile robotic device. Controlling the moveable sensor arrangement of the mobile robotic device may be based on images received from the fixed sensor arrangement. For example, the images may be used to determine the location of the object. The movable sensor arrangement may be controlled to be closer to the object in comparison to the static sensor arrangement, thereby allowing the at least one moveable camera to observe the object in more detail.

At block 1008, method 1000 includes receiving, from the at least one moveable camera of the moveable sensor arrangement, one or more additional images representative of the object. These additional images of the object may observe the object in more detail and give the robotic device more information from which subsequent steps may be inferred.

One such subsequent step that may be inferred from the additional images is controlling a component on the robotic device, e.g. an end effector. In some examples, if a robotic device infers from the additional images that the object is something that might be facile to manipulate, e.g. a small box, the robotic device may move the end effector towards the object and manipulate the object as requested. In other examples, if a robotic device infers from the additional images that the object is something that might be difficult to manipulate, e.g. a long rod, the robotic device may leave the object and/or request assistance.

In some examples, the one or more additional images taken from sensors on the moveable sensor arrangement of the robotic device may have a higher angular resolution, which may allow for distinguishing more minute details of an object, than the images taken from the static sensor arrangement on the robotic device. The angular resolution may be based on pixel density, e.g. the number of pixels per unit area. A robotic device where the moveable sensor arrangement is associated with the static sensor arrangement may be especially efficient in that a task may use the most appropriate component (either the static sensor arrangement or the moveable sensor arrangement) to avoid unnecessary processing. For example, avoiding objects in the surroundings, identifying objects, and other tasks that do not necessarily need higher resolution imaging but would benefit (e.g. be more efficient) from more data representing the surroundings may use the static sensor arrangement for lower resolution imaging, whereas tasks requiring a more detailed view of an aspect of the surroundings requiring higher resolution (typically dependent on what is perceived in the environment) may be offloaded to the moveable sensor arrangement. In this way, processing of data may be efficient such that 360 horizontal fields of views are not obtained through moving cameras with high resolution (which may provide vast amounts of data) and limited fields of view (which may be time intensive). Similarly, all images of the 360 field of view may not be used to observe small objects (which may only take up a small portion of the entire field of view) in detail.

In further examples, a fixed perception component of a robotic device or another component on the robotic device may incorporate at least one millimeter wave radar sensor, which may improve depth sensing and reduce dependence on the static sensor arrangement. Millimeter wave radar sensors may have the ability to gather information on the surroundings with a 360 degree field of view and through dielectrics (e.g. plastic, cardboard, fabric), thus, a single millimeter wave radar sensor may be placed inside the robot to provide a 360 degree horizontal field of view of the surroundings. Such a placement inside the robotic device may easily conceal the location and reduce the footprint of the sensor.

Additionally or alternatively, at least one LIDAR sensor may be incorporated into the fixed perception component of the robotic device or another component on the robotic device to similarly help improve depth sensing and reduce dependence on the static sensor arrangement. For example, the LIDAR sensor may be incorporated on the front of the robot to be used primarily for navigation and/or mapping or on the top of the robot to provide approximately 360 degree horizontal field of view with the exception of areas in the immediate vicinity of the robot due to self occlusions. Multiple LIDAR sensors may also be used in configurations similar to static sensor arrangement 500, 600, or 700 to decrease the amount of blind spots or dead zones that prevent the robotic device from visualizing its environment.

### III. Conclusion

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software or hardware modules in the same physical device. However, other information transmissions may be between software modules or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A mobile robotic device, comprising:
a static sensor arrangement, comprising at least two fixed cameras on the mobile robotic device, wherein a field of view of each of the at least two fixed cameras overlaps a field of view of a different one of the at least two fixed cameras, and wherein the at least two fixed cameras have a combined 360 degree horizontal field of view around the mobile robotic device; and
a moveable sensor arrangement, comprising at least one movable camera on the mobile robotic device, wherein the at least one movable camera has a higher angular resolution than each of the at least two fixed cameras.

2. The mobile robotic device of claim 1, wherein the moveable sensor arrangement is located on an end of arm component on the mobile robotic device, wherein the end of arm component is a moveable component of the mobile robotic device configured to manipulate objects.

3. The mobile robotic device of claim 2, wherein the movable sensor arrangement further comprises an illumination source.

4. The mobile robotic device of claim 3, wherein the illumination source is configured to output ultraviolet light.

5. The mobile robotic device of claim 1, wherein the at least two fixed cameras are red green blue (RGB) cameras.

6. The mobile robotic device of claim 1, wherein the at least one moveable camera is an RGB camera.

7. The mobile robotic device of claim 1, wherein the at least two fixed cameras have a combined vertical field of view of less than 360 degrees.

8. The mobile robotic device of claim 1, wherein the at least two fixed cameras are two fixed cameras each with an individual horizontal field of view of greater than 180 degrees.

9. The mobile robotic device of claim 1, wherein the at least two fixed cameras are four fixed cameras each with an individual horizontal field of view of greater than 90 degrees.

10. The mobile robotic device of claim 1, wherein the at least two fixed cameras comprise at least two vertically aligned pairs of fixed cameras.

11. The mobile robotic device of claim 10, wherein each camera in a vertically aligned pair from the at least two vertically aligned pairs of fixed cameras partially share a common field of view.

12. The mobile robotic device of claim 1, wherein the at least two fixed cameras each have substantially same degrees of field of view.

13. The mobile robotic device of claim 1, wherein the at least two fixed cameras each have differing degrees of field of view.

14. A method comprising:
receiving, from at least two fixed cameras in a static sensor arrangement on a mobile robotic device, one or more images representative of an environment of the mobile robotic device, wherein a field of view of each of the at least two fixed cameras overlaps a field of view of a different one of the at least two fixed cameras, and wherein the at least two fixed cameras have a combined 360 degree horizontal field of view around the mobile robotic device;
determining, from the one or more images, a presence of an object in the environment of the mobile robotic device;
controlling a moveable sensor arrangement of the mobile robotic device to move towards the object, wherein the movable sensor arrangement comprises at least one movable camera on the mobile robotic device; and
receiving, from the at least one movable camera of the moveable sensor arrangement, one or more additional images representative of the object.

15. The method of claim 14, further comprising determining a geometry of the object of the mobile robotic device from the one or more additional images representative of the object.

16. The method of claim 14, wherein controlling the moveable sensor arrangement of the mobile robotic device to move towards the object is performed in response to determining the presence of the object.

17. The method of claim 14, wherein the one or more images representative of the environment of the mobile robotic device comprise at least two images with overlapping horizontal fields of view.

18. The method of claim 14, wherein the one or more images representative of the environment of the mobile robotic device comprise one or more pairs of images having one or more overlapping vertical fields of view.

19. The method of claim 14, wherein the at least one movable camera has a higher angular resolution than each of the at least two fixed cameras.

20. A non-transitory computer readable medium of a mobile robotic device comprising program instructions executable by at least one processor to cause the at least one processor to perform functions comprising:
receiving, from at least two fixed cameras in a static sensor arrangement on the mobile robotic device, one or more images representative of an environment of the mobile robotic device, wherein a field of view of each of the at least two fixed cameras overlaps a field of view of a different one of the at least two fixed cameras, and wherein the at least two fixed cameras have a combined 360 degree horizontal field of view around the mobile robotic device;
determining, from the one or more images, a presence of an object in the environment of the mobile robotic device;
controlling a moveable sensor arrangement of the mobile robotic device to move towards the object, wherein the movable sensor arrangement comprises at least one movable camera on the mobile robotic device; and
receiving, from the at least one movable camera of the moveable sensor arrangement, one or more additional images representative of the object.
